(19) United States
(12) Patent Application Publication
(10) Pub. No.: US 2006/0192940 A1
(43) Pub. Date: Aug. 31, 2006

(54) Modular flow cytometry system

(76) Inventor: Janette Trang Phi-Wilson, Los Altos Hills, CA (US)

Correspondence Address: LAW OFFICE OF KENNETH A. MURRAY, JR., P.O. BOX 2188, DAVIS, CA, 95617, US

(21) Appl. No.: 11/336,424

(22) Filed: Jan. 20, 2006

Related U.S. Application Data
(60) Provisional application No. 60/645,787, filed on Jan. 20, 2005.

(51) Int. Cl. G01N 15/02; G01N 21/00

(52) U.S. Cl. 356/73; 356/336

(57) ABSTRACT

The present invention provides a novel flow cytometry system having high sample cell throughput with simultaneous single and multi-parameter development, extraction and analysis. The invention is comprised of one or more analytic modules or chips aggregated into a stack or chain creating a common laser light transmission channel while maintaining a separate fluid sample flow path within each chip. Each flow chip includes an array of optical fiber light receivers. Each chip also includes integrated waveguides to receive and channel scatter, reflected or fluoresced light of specific frequency and wavelength to the optical fiber receiver. One or more waveguides and optical fiber receivers may be incorporated within each flow chip. Each sensing optical fiber delivers its received light emission to an electro-optical system signal processing module for measuring, digitizing and identifying the light signal.

### CROSS-REFERENCE TO RELATED APPLICATIONS

Priority is claimed to U.S. Provisional Application No. 60/645,787 filed Jan. 20, 2005, titled “MODULAR FLOW CYTOMETRY SYSTEM,” which is referred to and incorporated herein in its entirety by this reference.

### STATEMENT REGARDING FEDERALLY SPONSORED RESEARCH OR DEVELOPMENT

Not Applicable

### SEQUENCE LISTING OR PROGRAM

Not Applicable

### FIELD OF INVENTION

This invention relates to a system for analyzing parameters of microparticles based upon flow cytometry techniques. More particularly, this invention relates to such a system having modular and scalable components for enhanced sensitivity and ability to detect one or more parameters simultaneously from one or more fluid samples using a single laser light source.

### BACKGROUND

Flow cytometry involves the analysis of the fluorescence and light scatter properties of single particles, such as cells, nuclei and chromosomes, during their passage within a narrow, precisely defined liquid stream.

A typical flow cytometer consists of several basic components: a light source, a flow chamber and optical assembly, photodetectors and processors to convert light signals into analog electrical impulses, analog-to-digital converters, and a computing system for analysis and storage of digitized data.

Flow cytometers involve sophisticated fluidics, laser optics, electronic detectors, analog to digital converters, and computers. The electronics quantify faint flashes of scattered and fluoresced light. The computing system records data for thousands of cells per sample, and displays the data graphically.

The fluidics of the cytometer hydrodynamically focus the cell stream to within an uncertainty of a small fraction of a cell diameter to cause the cell particles to travel sequentially in single file through the flow chamber portion of the cytometer. Various flow chamber configurations have been developed with differing flow velocities. Typically, the higher the flow velocity, the lower the sensitivity of the cytometer since each cell particle spends less time in the analytic portion of the flow chamber, providing less time to gather fluoresced and reflected light, and hence, less data useable for assessing the particular particle.

The optical system of a flow cytometer focuses one or more laser beams on the target stream of cells passing through the flow chamber. Typically, the optics deliver laser light focused to a beam a few cell diameters across. The flow cytometer is cable of measuring various particle parameters based upon light scatter and light fluorescence created by the imposition of the laser light on each particle. Scatter parameters can provide indications of a cell's size, granularity, membrane complexity and number of organelles. Fluorescence parameters can provide information specific to the microparticle being studied, other than physical or geometric features. For example, proteins with specific antibodies may be detected, suggesting specific immunofluorescence. Also, DNA content may be measured to provide information concerning cell cycle and proliferation. Further, apoptis, mithochondrial function, oxidative bursts, reporter genes, glutathione/reductive reserve, Calcium ion flux, pH, cell division and conjugation, total protein content and cell-mediated cytotoxicity are additional examples of information that may be derived using flow cytometry.

Flow cytometry uses electro-optical techniques to provide the quantitative analyses of various cell properties where the cells are sequentially studied in a continuous flow system. On the basis of the measured properties of each cell particle, the cells may then be physically isolated for their use in biological studies. Cells and subcellular constituents, such as chromosomes, can be analyzed and sorted. The greater the volume of data available for analyzing each cell as it passes through the cytometer flow chamber for subsequent sorting, the greater the ability to sort each cell according to specific features or properties.

Flow cytometry is typically used in laboratory environments for biological and biomedical research and is also used in clinical data collection environments. However, in light of recent threats of bioterrorism, great interest has developed in creating cell detection systems possible of quickly identifying a potentially hazardous substance in a sample stream. Due to the size and cost of existing laboratory or clinically-based flow cytometry systems, they are not effective for use in a field triage setting where mobility is critical.

Most current flow cytometry systems use the laser light source inefficiently. A single laser beam is focused on one sample cell stream as it passes through the flow chamber. The reflected or fluoresced light from each target cell is detected and transmitted through various optical band-pass filters. As the photonic response from each cell is transmitted through each filter, the signal strength of the collected photonic response is reduced. This signal strength reduction limits the number of sequential filters which may be applied to the signal before it is undetectable. Consequently, there is a limit to the number of parameters which may be analyzed for each target cell, generally four to seven. If the target cell is an unknown, this number is insufficient to quickly identify a target cell in a single pass through a typical flow cytometry system. In addition, the strength of various signal frequencies from a cell target can be insufficient to even be detected by available sensor technology. Consequently, a potentially relevant cell property may go undetected, thereby causing a researcher to miss a cell type relevant to the analysis.

Consequently, a need exists for a system using flow cytometry methodology that is capable of measuring a plurality of parameters from a single target cell simultaneously without subjecting the target cell photonic response signal to a series of sequential band-pass filters causing the target response signal to quickly degrade.

Further, a need exists for a cell detection system where target response signals may be simultaneously aggregated to increase the signal strength to a level sufficient to allow current detector technology to become aware of the presence of a particular particle of interest.

Additionally, a need exists for a particle detection system capable of detecting smaller particles more expeditiously.

And further, a need exists for a particle detection system capable of quickly identifying an unknown particle from an extensive list of known substances of interest in a non-laboratory environment.

### OBJECTS OF THE INVENTION

A first object of the invention is to provide a flow cytometry system with multiple light receivers embedded in a flow chip capable of simultaneously collecting light of differing frequencies reflected off target samples or fluoresced by target samples.

A second object of the invention is to provide a flow cytometry system where the collected reflected or fluoresced light is not degraded or weakened for each additional parameter analyzed.

A third object of the invention is to provide a capillary flow cytometry system having detection sensitivity equal to or greater than that of a fluid sheath flow cytometry system.

A fourth object of the invention is to provide a flexible and scalable modular flow cytometry system where additional analytic elements or flow modules may be added in any combination to detect additional parameters of material in the carrier fluid or to increase the flow rate of particles of interest and hence, the sensitivity of the flow cytometry system.

A fifth object of the invention is to provide an adaptable flow cytometry system whose physical size is small enough to be packaged in a hand-held device.

A sixth object of the invention is to provide a flow cytometry system capable of detecting very small targets carried in the fluid sample at a very high flow rate.

A seventh object of the invention is to provide a flow cytometry system capable of operation in a field or non-laboratory environment.

An eighth object of the invention is to provide a micro-flow cytometry system where each individual module includes light receivers, filters and wave guides tuned to look for specific properties associated with the presence of a particular particle of interest.

### BRIEF DESCRIPTION OF THE DRAWINGS

FIG. 1 is a schematic diagram of the primary components of a flow cytometry system according to the present invention.

FIG. 2 is a perspective view of an aggregation of a plurality of flow chip wafers according to the present invention.

FIG. 3 is an exploded view of a stack of a plurality of flow chip wafers according to the present invention.

FIG. 4 is a perspective view of an individual flow chip wafer according to the present invention.

FIG. 5 is a perspective view of a half-wafer of an individual flow chip according to the present invention.

FIG. 6 is a perspective view of the capillary flow chamber assembly of the flow cytometry system according to the present invention.

FIG. 7 is a schematic of the multi-parameter processing capability of the flow cytometry system according to the present invention.

FIG. 8 is a schematic of the single parameter processing capability of the flow cytometry system according to the present invention.

FIG. 9 is a schematic of the combined single parameter and multi-parameter processing capability of the flow cytometry system according to the present invention.

FIG. 10 is a schematic of the flow cytometry system according to the present invention wherein individual flow chips are connected via optical fibers.

### SUMMARY OF THE INVENTION

The present invention provides a novel flow cytometry system having high sample cell throughput with simultaneous single and multi-parameter development, extraction and analysis. The invention is comprised of one or more analytic modules or chips aggregated into a stack or chain creating a common laser light transmission channel while maintaining a separate fluid sample flow path within each chip.

Each flow chip includes an array of optical fiber light receivers. Each chip also includes integrated waveguides to receive and channel reflected or fluoresced light of specific frequency and wavelength to the optical fiber receiver. One or more waveguides and optical fiber receivers may be incorporated within each flow chip. Each sensing optical fiber delivers its received light emission to an electro-optical system for measuring, digitizing and identifying the light signal.

Aggregation of two or more flow modules allows simultaneous analysis of a single fluid sample for single or multiple parameters, or, simultaneous analysis of multiple fluid samples for single or multiple parameters. The analysis is accomplished using only a single laser light source to generate fluoresced, reflected or scattered light signals which are transmitted through corresponding wave guides or band pass filters or delivered directly to a fiber optic receiver to simultaneously identify multiple characteristics of the material contained in the sample passing through the common flow channel or to identify the presence of various materials within the fluid sample.

Integrated Flow Stack and Aggregating Sensor Array

The sensor array, through the combined use of a plurality of micro-mechanical wave guides and fiber optics receptors, creates multiple data collection points directly at the signal source adjacent the object of interest in the flow channel. In one configuration, the photons collected from the fiber sensor array are aggregated to increase sensitivity to a single parameter of interest. In another configuration, the collected photons remain segregated to identify a plurality of parameters simultaneously.

The fiber optic sensor array is created using MEMS technology with 2D or 3D photolithography. The design of the present invention provides for miniaturization and mass production of the sensor/flow block.

Multiple Channel-Single Laser Approach for Parallel Sampling

In this embodiment, multiple sensor chips provide parallel, concurrent sample analysis using a single laser beam source. The laser light channel uses an optical fiber to carry the focused laser beam from the output end of the laser to the cytometer chip laser light channel. As the laser beam passes through each chip exciting various particles of interest, the beam is recollimated and focused via another optical fiber or optical lens. The recollimated and refocused beam is then used to excite target particles traveling through the sample flow conduit in the next chip. This continuous process allows parallel, simultaneous analysis of multiple samples using a single laser light source.

Flexible Signal Detection Methods

The photons collected from the fiber sensor array can be aggregated to increase overall sensitivity of the system to one or more parameters. Alternatively, each individual fiber may deliver its photon signal to a separate photonic sensor for identification of only one parameter. Alternatively, some fibers may deliver signals to a separate sensor while others are aggregated to increase sensitivity to a particular target of interest. Various types of readily available photonic sensors may be used to identify characteristics of interest in specific frequency ranges.

Tunable-Laser Light Source

In an alternative embodiment, the present invention's detection functionality may be further expanded by using a tunable laser as the primary light source to generate a plurality of laser light packets at varying frequencies to increase the number of potentially observable parameters. Various particles will fluoresce at different laser light frequencies. Additionally, where other particles are attached to targets within a sample, the laser light may be separately tuned to identify these other particles with known fluorescence frequencies and known affinity for attachment to specific particle types.

### DETAILED DESCRIPTION OF THE INVENTION

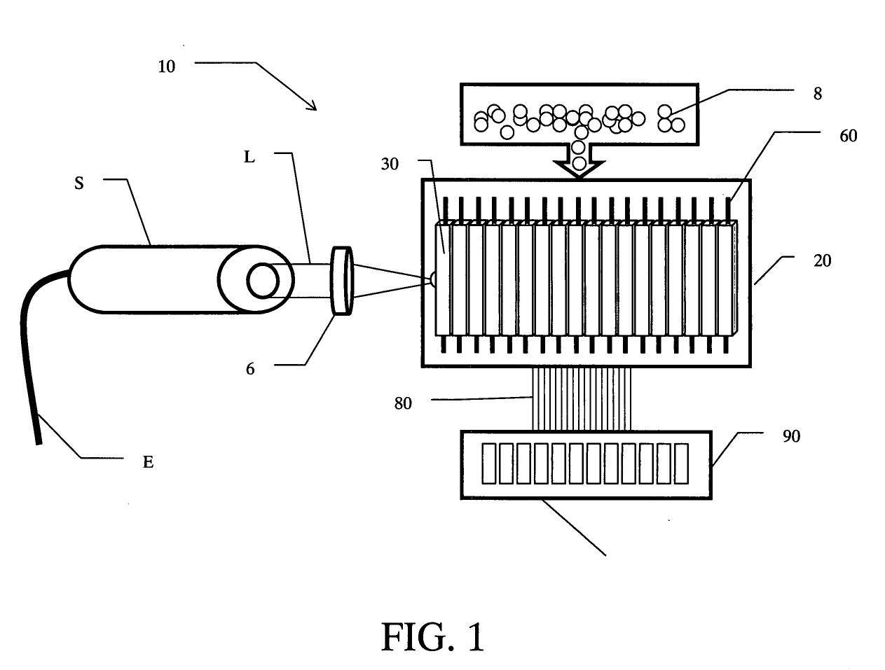

Referring to FIG. 1, a flow cytometry system 10 according to the present invention is comprised of a laser light source S connected to a power source E to generate a laser light beam L. The laser beam L passes through an optical focal lens 6. A sample solution storage reservoir 8 delivers samples to a flow stack 20 containing at least one flow chip 30. The flow chip 30 includes a centrally disposed flow chamber assembly 60. A signal transmission optical fiber 80 transmits scattered and fluoresced optical signals from the flow chip 30 to a photonic signal processing and analysis module 90.

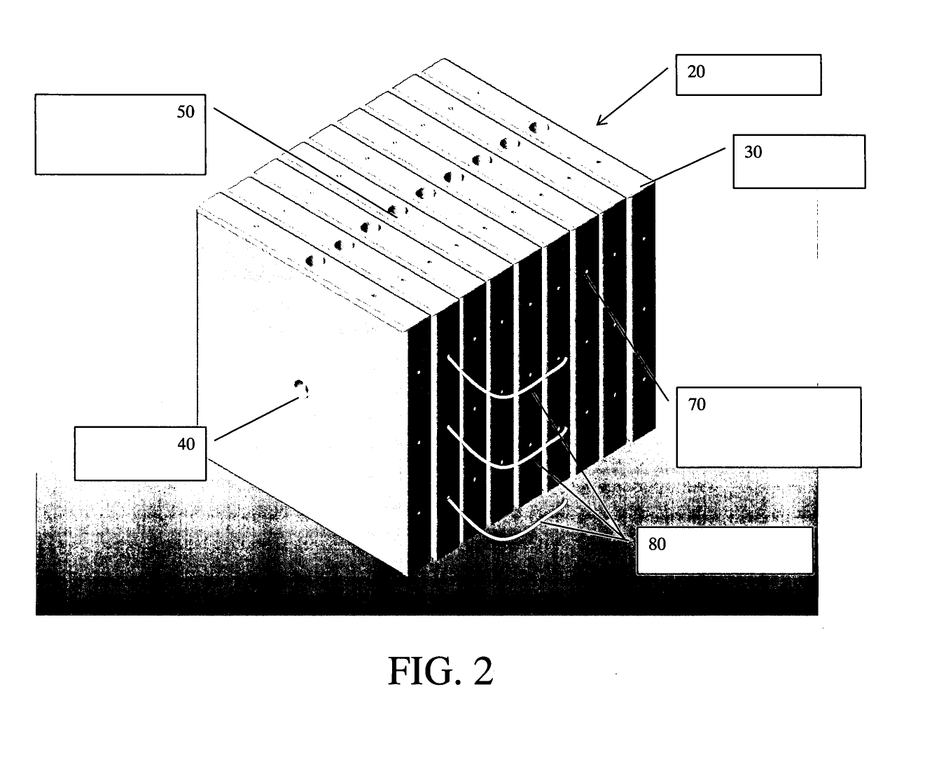

Referring to FIG. 2, the system 10 of the present invention includes a flow and detection module assembly, hereinafter, a flow stack 20. The flow stack 20 is comprised of one or more flow chips 30. A flow chip 30 includes a centrally-located laser light orifice 40 for receiving and transmitting the laser light beam. The flow chip 30 is laterally transected and bisected by a flow chamber cavity 50, which intersects the laser light orifice 40. The flow chamber cavity 50 receives and houses a capillary flow chamber assembly 60. Integrated waveguides 70 are distributed about and penetrate the periphery of the flow chip 30 intersecting at the laser light orifice 40. Optical fibers 80 are disposed to connect with the optical waveguides 70 and to connect to other external processing and analytical equipment.

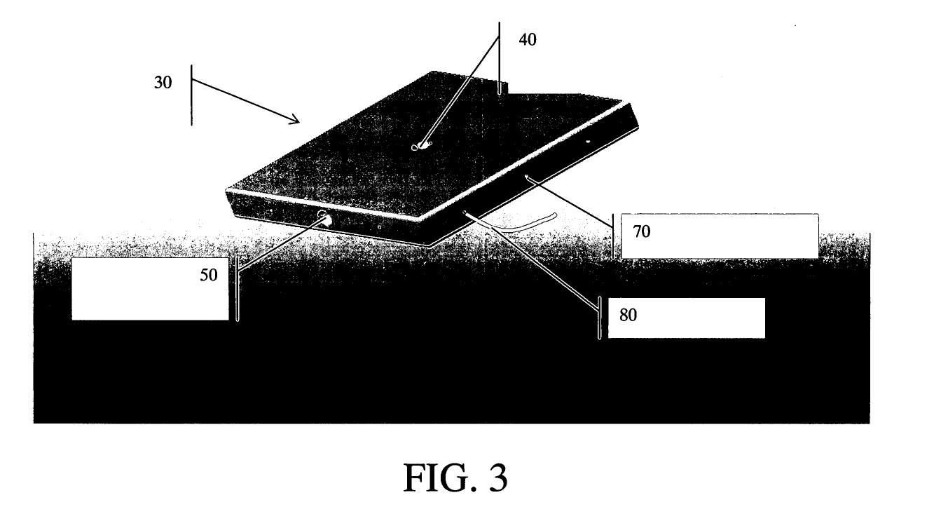

Referring to FIG. 3, an individual flow chip 30 is shown. The flow chip 30 is penetrated at its center by a laser light orifice 40. A laser light recollection, collimation and focal lens 42 is aligned with the laser light orifice 40 and mounted on a discharge side of the flow chip 30. The focal lens 42 recollimates, focuses and transmits the recollected laser beam L from a preceding flow chip 30 to the front side of the orifice 40 of a subsequent flow chip 30. The flow chip 30 includes a flow chamber cavity 50 to receive a flow chamber assembly 60. The flow chamber cavity 50 intersects the laser light orifice 40. One or more waveguide channels 70 penetrate the flow chip 30 to intersect at the perimeter of the laser light orifice 40. Optical fibers 80 extend from each waveguide channel 70 to transmit optical signals to external processing units.

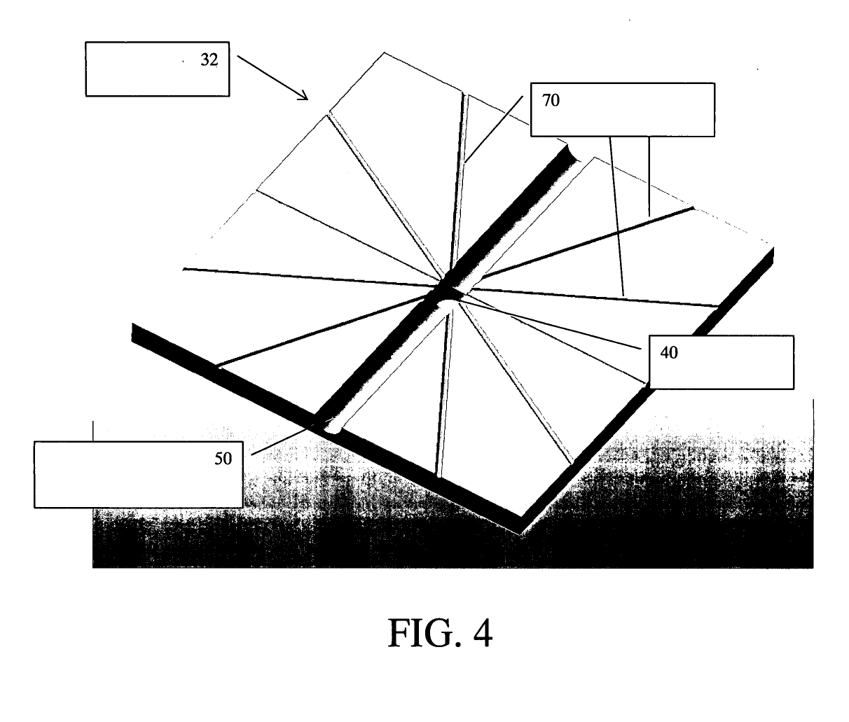

Referring to FIG. 4, a half wafer 32 of a flow chip 30 is shown. As illustrated, the flow chamber cavity 50 intersects the laser light orifice 40. The flow chamber cavity 50 would generally have a diameter between 25 and 400 micrometers, depending on the size of a flow chamber assembly 60 to be used based on the size of particles of interest to be analyzed. One or more waveguide channels 70 penetrate the flow chip 30 from its edges to intersect at the periphery of the laser light orifice 40. A complete flow chip 30 is comprised of two half wafers 32. Once the two half wafers 32 are assembled, the capillary flow chamber 60 will lay centered in the chip flow chamber cavity 50 with a cellulitic flow sheath 62 of the flow chamber assembly 60 located adjacent to the laser light orifice 40. A midline of the cellulitic flow sheath 62 is aligned with a center axis of the laser light orifice 40. Optical fibers 80 will be connect with the optical waveguide pathways 70. Two flow chip wafer halves will be bonded together to form a complete individual flow chip 30, housing the flow chamber 60 centrally disposed within the flow chamber cavity 50, forming the waveguides 70 and securing the optical fibers 80. A recollimation lens 42 (not shown) is centrally mounted in the laser light orifice 40 on the discharge side of the wafer half 32 of the flow chip 30.

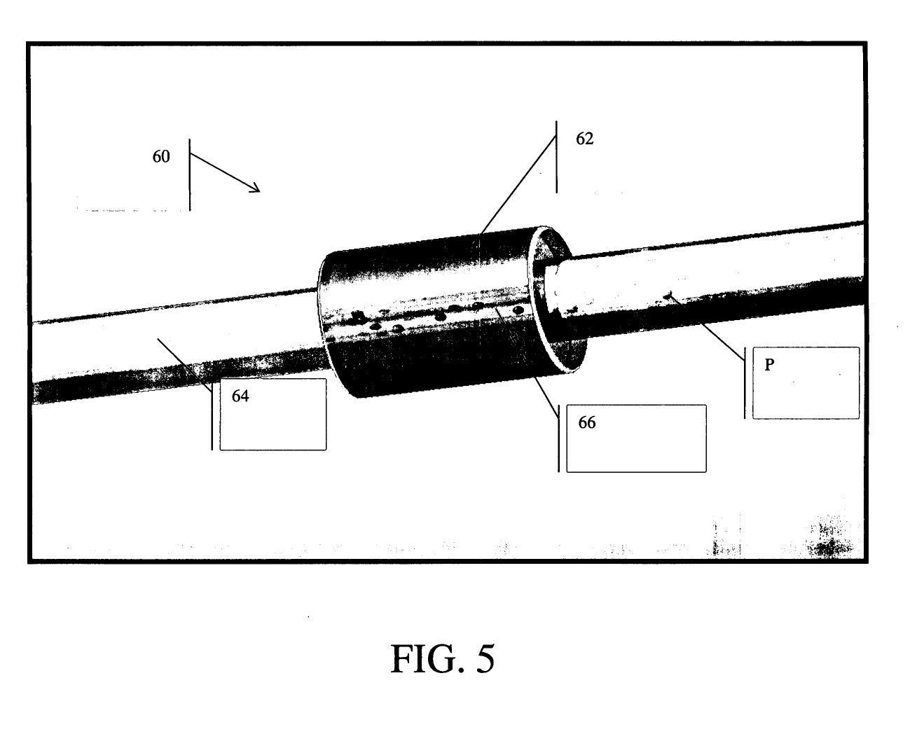

Referring now to FIG. 5, a flow chamber assembly configuration 60 of the system 10 of the present invention is shown. The flow chamber 60 includes a cylindrical cellulose sheath 62. The sheath 62 is wrapped around a glass capillary tubing 64. The refractive index of the sheath 62 and the capillary tubing 64 are essentially equivalent to prevent distortion of any scattered or fluoresced light generated by the excitation of any particles of interest P. The capillary tubing 64 includes a capillary flow conduit 66 which receives the fluid sample carrying the particles of interest P. The flow chamber 60 is centrally disposed within the flow chamber cavity 50 with the cellulose sheath 62 aligned at its midline with the laser light orifice 40. The flow conduit 66 of the capillary tubing 64 of the flow chamber assembly 60 is sized to receive a fluid sample containing particles of interest P of a particular size, ensuring that the particles P travel in single file as they pass through the flow chamber 60, causing each particle P to be individually excited by the laser light beam L.

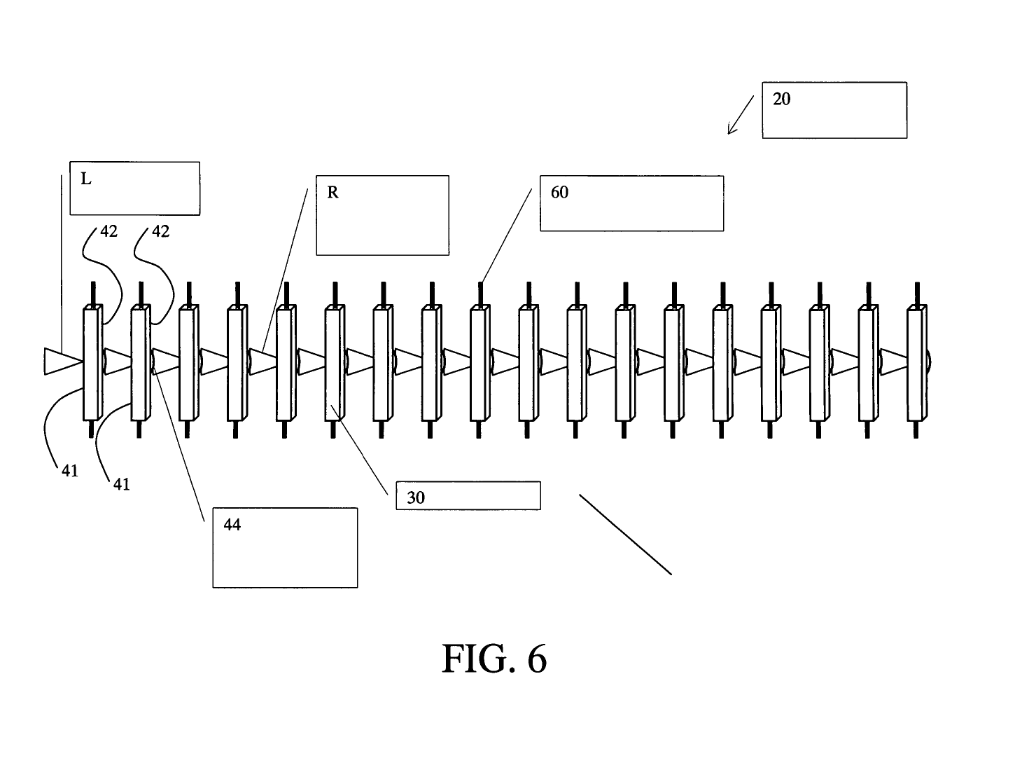

Referring now to FIG. 6, the flow stack 20 of the system 10 of the present invention is described in greater detail. As illustrated in an exploded view, in the flow stack 20, an initial laser light beam L is first targeted at the laser light orifice 40 of the first flow chip 30 of the stack 20. As the laser beam L passes through the laser light orifice 40 of the first chip 30, the beam L passes cellulose sheath 62 and the capillary tubing 64 of the flow chamber assembly 60 to impinge upon and excite various particles of interest P traveling through the capillary flow conduit 66. In the present invention, the refractive index of the cellulose sheath 62 and the capillary tubing 64 are selected so as to be essentially equivalent to the refractive index of the sample solution to minimize distortion of both the laser beam L and any reflected or fluoresced light signal generated by an excited particle. However, some distortion of the beam L will occur as it travels through the illumination zone of each flow chip 30. A recollimation lens 42 centrally disposed within the laser light orifice 40 on the discharge side of a flow chip 30 collects and recollimates the distorted initial laser light beam L to form a recollimated light beam R. The recollimated light beam R is then delivered to the next flow chip 30 where it once again impinges upon and excites particles of interest P traveling through the flow chamber 60 of that flow chip 30. As shown in FIG. 6, the process of applying the laser beam L to each flow chip 30 and then recollimating the beam R for use in the next flow chip 30 can continue for as many flow chips 30 and individual fluid samples for so long as there is sufficient energy in the recollimated beam R to excite potential particles of interest P.

Referring once again to FIG. 2 and FIG. 3, although the flow chip 30 is shown for simplicity as shaped in a flat square for use in a stack configuration 20, a flow chip 30 may be formed in any shape as long as a rear surface of a first flow chip 30 is able to mate with the front surface of a subsequent flow chip 30 to properly align the laser light orifices 40 of both chips. In any flow stack 20, the individual flow chips 30 are coupled so as to accurately align each individual laser light transmission orifice 40 to allow transmission of a single laser light beam L through multiple flow chambers 60 in multiple flow chips 30.

Likewise, although the laser light orifice 40 is shown in FIG. 4 as being located in the center of the square flow chip 30, one skilled in the art will recognize that the laser light orifice 40 may penetrate the chip 30 at other locations rather than the center without disturbing the function of the system 10 as long as the flow chamber cavity 50 and the laser light orifice 40 remain aligned to intersect and create a particle excitation zone.

Referring once again to FIG. 6, the laser light orifice 40 is sized to receive a laser beam L. An input side 41 of the orifice 40 carries the laser beam L to impinge on a target particle of interest P present in the flow chamber 60 adjacent the orifice 40. An output side 42 of the orifice 40 includes a recollimation lens 44 which refocuses and transmits the laser beam L to a corresponding input side 41 of the orifice 40 of a subsequent flow chip 30. Once again, the laser light L illuminates target particles of interest P present in the flow chamber 60 of the subsequent flow chip 30.

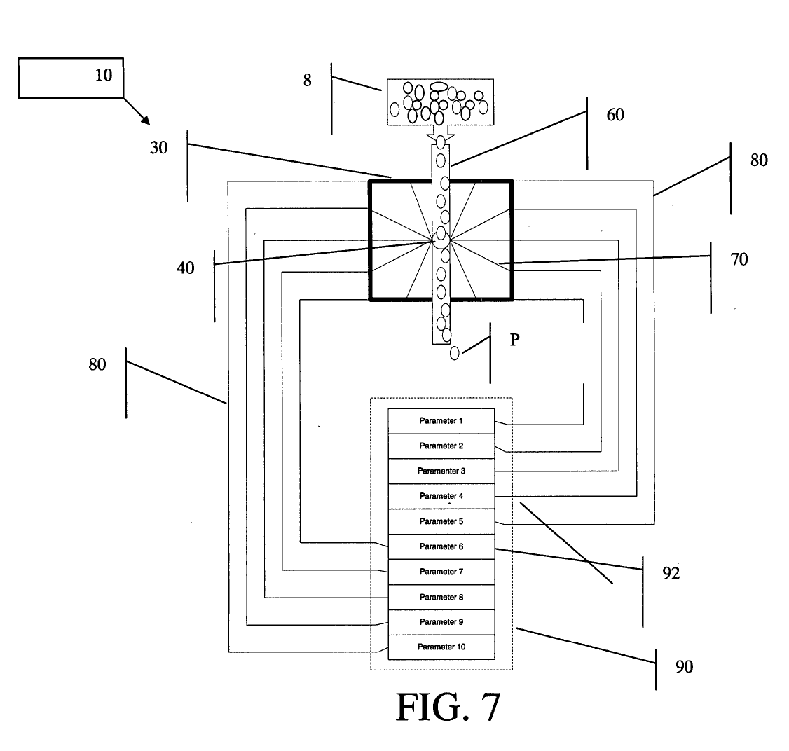

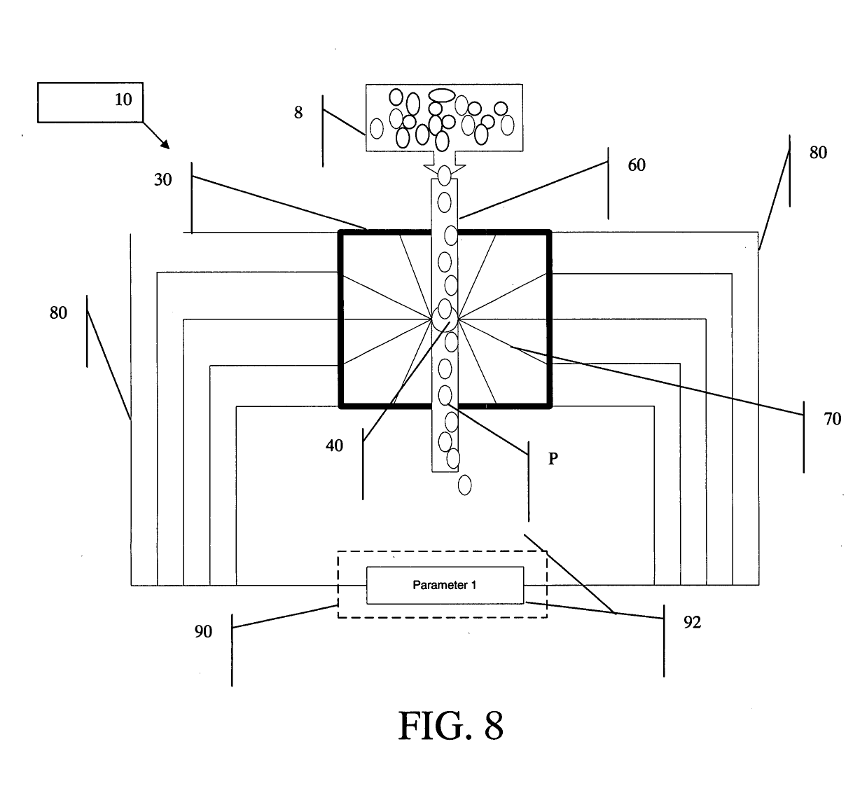

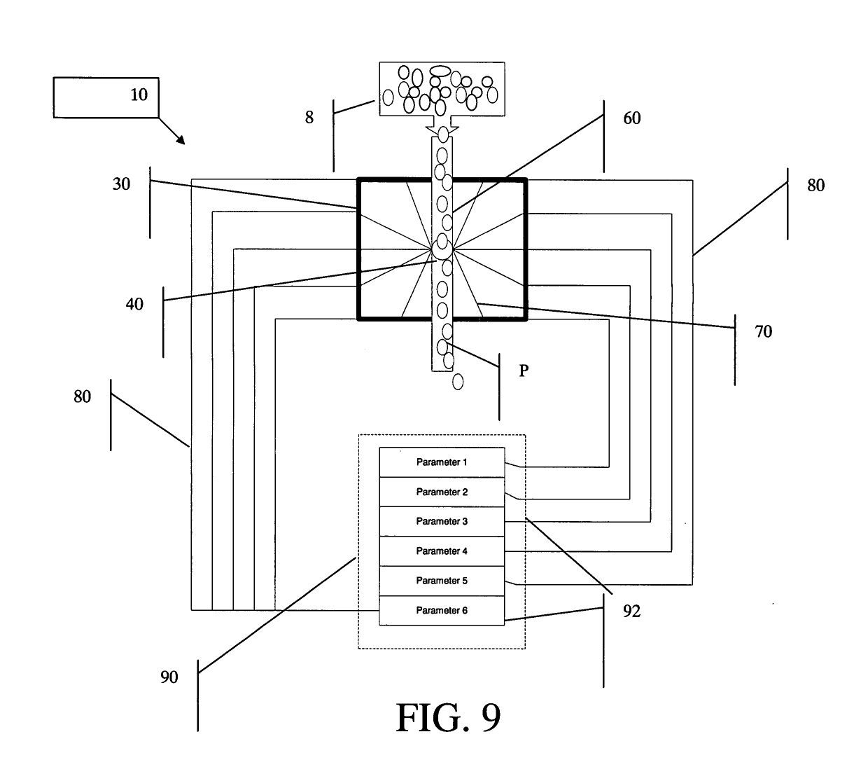

Referring now to FIG. 7, FIG. 8 and FIG. 9, a schematic diagram of the system 10 of the present invention with the various signal processing configurations and associated methodology are described.

Multi-parameter Signal Processing Configuration and Method

Referring to FIG. 7, the primary components of the system 10 are illustrated and the method of multi-parameter processing of output signals is described. A sample solution reservoir 8 delivers a fluid sample and entrained target particles of interest P to the system flow chamber 60 centrally disposed within the flow chip 30. As each particle P travels through the flow chamber 60, it eventually passes through the portion of the flow chamber 60, the illumination zone, which is illuminated by the laser beam L and located adjacent the laser light orifice 40 of the flow chip 30. When each particle P passes through the illuminated zone of the flow chamber 60, the particle P is energized in some manner by the laser beam L to create either scattered or fluoresced light. The output light signal is then captured by the various waveguides 70 distributed about the perimeter of the laser light orifice 40 of the flow chip 30. Each waveguide 70 is tuned to a light signal of a particular frequency. If the energized particle P emits a signal of the frequency specific to a particular waveguide, the signal is transmitted via the waveguide 70 to a collection optical fiber 80 and then to the signal processing module 90 where it is then delivered directly to its associated parameter processing unit 92 specific to the waveguide 70 frequency.

As shown in FIG. 7, the multi-parameter processing methodology of the present invention 10 provides for capturing ten distinct photonic signals from each energized particle P. Ten separate waveguides 70 are designed to capture 10 distinct light signal frequencies which are then delivered to ten distinct parameter processing units 92. Consequently, as each individual particle P is energized, the system 10 is capable of analyzing the particle for ten distinct parameters simultaneously and in parallel.

When configured in a stack 20 as illustrated in FIG. 1, FIG. 2, and FIG. 6, the output signals of each flow chip 30 may be processed by the same signal processing unit 90. Consequently, the output of each flow chip 30 may be aggregated with the output of every other flow chip 30, increasing the detection sensitivity of the overall system 10, specific to the particular parameters of interested defined by the waveguides 70.

Once light signals have been delivered and then processed by the signal processing module 90, the output data is transmitted to an external device capable of displaying or storing the data in a usable form. The external device may be the display of a hand-held personal digital assistant, the display of a desktop computer, the display of a lap top computer, and various forms of digital storage devices.

In another configuration, instead of waveguides 70, the flow chips 30 will simply have optical fibers 80 disposed about the perimeter of the laser light orifice 40 of the chip 30. In this configuration, the light signal is not preprocessed by waveguides 70 incorporated within the chip 30, but instead, is delivered in raw, unprocessed form to external processing devices. External processing devices may include other types of waveguides, band-pass filters or other analytic devices used for processing light signals.

Aggregated Single Parameter Signal Processing Configuration and Method

Referring now to FIG. 8, the system and method of single parameter processing of aggregated signals according to the present invention is described.

A sample solution reservoir 8 delivers a fluid sample and entrained target particles of interest P to the system flow chamber 60 housed in the flow chip 30. As each particle P travels through the flow chamber 60, it eventually passes through the portion of the flow chamber 60 illuminated by the laser beam L adjacent the laser light orifice 40 of the flow chip. When each particle P passes through the illuminated portion of the flow chamber 60, the particle P is energized in some manner by the laser beam L to create either scattered or fluoresced light. The output light signal is then captured by the various waveguides 70 distributed about the perimeter of the laser light orifice 40 of the flow chip 30. For single parameter processing, each waveguide 70 is tuned to a single light signal of a particular frequency. If the energized particle P emits a signal of the frequency specific to the waveguide, the signal is transmitted via the waveguides 70 to the collection optical fibers 80 and then to the signal processing module 90 where it is then delivered directly to its associated single parameter processing unit 92.

In the single-parameter configuration illustrated in FIG. 8, the single-parameter processing methodology of the present invention 10 provides for capturing a distinct photonic signal of the same frequency from ten separate collection points distributed about the perimeter of the laser beam orifice 40 for each energized particle P. These ten distinct signals of the same frequency may then be aggregated in one parameter processing unit 92 to maximize the intensity of the specific signal and enhance the sensitivity of the overall system 10.

Combined Multi-Parameter and Single Parameter Signal Processing Configuration and Method

Referring now to FIG. 9, the system and method of simultaneous multi-parameter and single parameter processing of signals according to the present invention is described.

A sample solution reservoir 8 delivers a fluid sample and entrained target particles of interest P to the system flow chamber 60 housed in the flow chip 30. As each particle P travels through the flow chamber 60, it eventually passes through the portion of the flow chamber 60 illuminated by the laser beam L adjacent the laser light orifice 40 of the flow chip. When each particle P passes through the illuminated portion of the flow chamber 60, the particle P is energized in some manner by the laser beam L to create either scattered or fluoresced light. The output light signal is then captured by the various waveguides 70 distributed about the perimeter of the laser light orifice 40 of the flow chip 30.

As shown in FIG. 9, five of the waveguides 70 are tuned to different signal frequencies and deliver their signals to five different signal parameter processing units 92 within the signal processing module 90. The other five waveguides 70 are tuned to a sixth frequency and all five collected signals are delivered to a sixth single parameter processing unit 92 of the processing module 90.

In this manner, the system 10 of the present invention can be configured to maximize sensitivity to a single identified parameter while still maintaining sensitivity to other distinct parameters. As in the other described configurations for multi-parameter and single parameter processing, combining multiple flow chips 30 in a stack 20 will allow a user to both increase sensitivity to a single parameter, to multiple parameters, or to maximize the number of parameters detected in a single detection device.

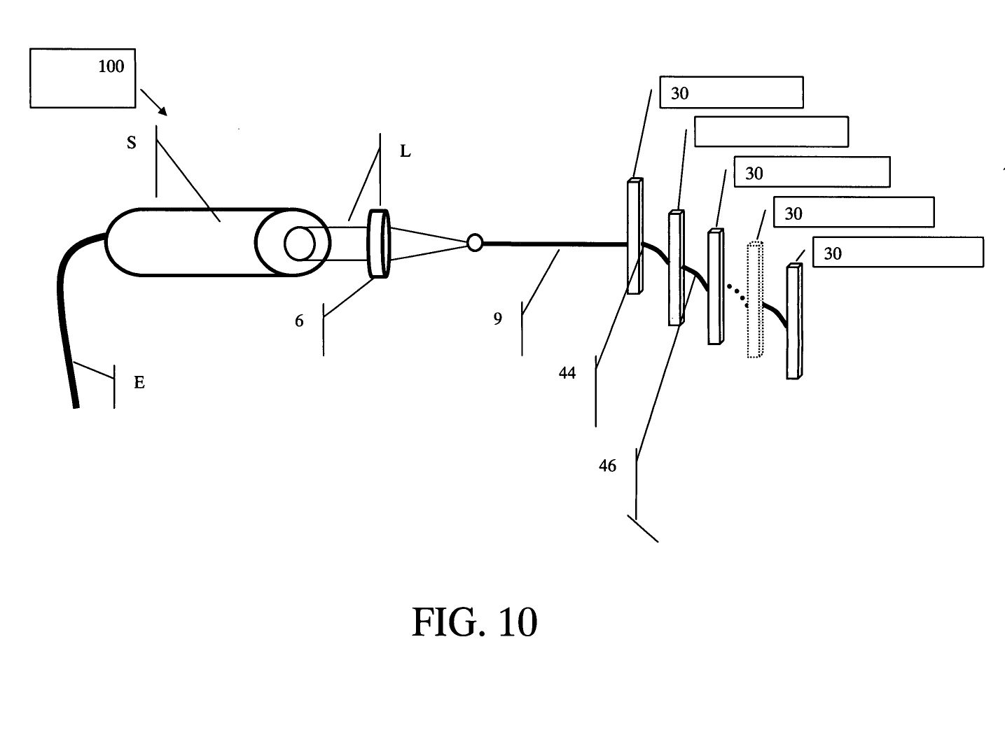

Referring now to FIG. 10, in an alternative embodiment 100, the flow cytometry system according to the present invention is described. The alternative embodiment 100 is comprised of a plurality of flow chips 30 where the flow chips 30 are not stacked immediately adjacent one another, but instead are connected by separate optical transmission, recollection and recollimation fibers 44. The laser light beam L is delivered to the first flow chip 30 by an initial laser beam delivery optical fiber 9. As the laser light beam L passes through each chip 30, the beam L is recollimated by a recollimation lens 42 and then delivered to the next flow chip 30 via a collection and recollimation optical fiber 44. In this embodiment, the flow chips 30 may be arranged in other configurations other than a stack configuration 20. This will allow flexibility in the design of hardware systems used to house the flow cytometry package.

While the foregoing has been with reference to particular embodiments of the invention, it will be appreciated by those skilled in the art that changes in these embodiments may be made without departing from the principles and spirit of the invention, the scope of which is defined by the appended claims and the preceding descriptions.

What is claimed is:

1. A flow cytometry system for measuring parameters of particles comprising:
a. A laser light source to produce a laser light beam
b. A first lens to receive and focus said laser light beam
c. A primary optical fiber attached to said lens to receive said focused laser light beam and to transport said beam to a desired location
d. At least one microflow chip having a laser light beam orifice, a fluid channel and at least one photonic wave guide
e. Wherein a discharge end of said primary optical fiber is positioned adjacent an entry side of said laser light beam orifice
f. At least one signal gathering fiber
g. Wherein a receiving end of said signal gathering fiber is positioned adjacent a signal discharge end of said wave guide
h. Wherein a discharge end of said signal gathering fiber is positioned adjacent a signal processing unit to deliver gathered signals to said signal processing unity for analysis

2. The system of claim 1 wherein said fluid channel conduit includes an inner wall of cellulose having an optical refractive index substantially similar to that of the sheath fluid carrying the target particles.

3. A flow cytometry system comprising two or more microflow chips wherein a light orifice of each said two or more chips is located in the same position in each of said two or more chips such that the two or more chips may be aggregated in a stack of two or more chips wherein a single light source may be applied to the stack for use by each of the two or more chips simultaneously, thereby providing for simultaneous detection of multiple parameters from each of two or more chips.

4. A flow cytometry system according to claim 3 wherein said multiple parameters are the same parameter.

5. A flow cytometry system according to claim 3 wherein some of the said multiple parameters are the same parameters and others of the said multiple parameters are different parameters.
